(19) United States
(12) Patent Application Publication
(10) Pub. No.: US 2014/0144303 A1
(43) Pub. Date: May 29, 2014

(54) VACUUM GRIPPER

(71) Applicant: Ralf-Peter Muller, Kempten (DE)

(72) Inventor: Ralf-Peter Muller, Kempten (DE)

(73) Assignee: CFS BUHL GMBH, Kempten (DE)

(21) Appl. No.: 13/825,998

(22) PCT Filed: Sep. 28, 2011
(86) PCT No.: PCT/EP11/04844

§ 371 Date: Apr. 10, 2013

(30) Foreign Application Priority Data
Oct. 1, 2010 (DE) 102010047078.3
Mar. 2, 2011 (DE) 102011012880.8

(51) Int. Cl. B26D 7/01

(52) U.S. Cl. CPC B26D 7/018
USPC 83/100; 83/452; 83/461; 83/465

(57) ABSTRACT

The invention relates to a gripper for use in a cutting machine, in particular a high-speed cutting machine. The gripper can be brought into engagement with an end of a food loaf in a reversible manner by applying a negative pressure.

The present invention relates to a gripper for use in a cutting machine, in particular a high-performance cutting machine, which can be brought reversibly into engagement with an end of a bar-shaped foodstuff by the application of a negative pressure.

Grippers of this kind are known fresh the prior art, for example EP 2 095 918, EP 2 095 920 and EP 2 095 919, and are used in high-performance cutting machines in which bar-shaped foodstuffs, for example meat, sausage and/or cheese in the shape of bars, are cut into slices of foodstuff. Here, before or during the cutting up of the bar-shaped foodstuff, the gripper is brought into engagement with the end thereof in order, during cutting up for example, to guide and/or stabilize this end piece and/or in order to dispose of an end piece that cannot be further cut up or is not to be cut up. In the case of the generic gripper, contact, in particular form fit and/or force fit, between the end of the bar-shaped foodstuff and the gripper is at least maintained by the application of a negative pressure acting between the gripper and the end of the bar-shaped foodstuff.

The grippers according to the prior art no longer meet modern hygiene standards, since they use piston and cylinder systems in which it is not possible to clean the annular surface between the piston and the cylinder and, because of the relative motion thereof with respect to one another,, it is not possible to prevent product from penetrating into this region as a lubricating film. Vacuum systems having extreme vacuum pumps are soiled as a result of particles of product penetrating into the vacuum line and, in particular if the product is expelled again by the action of compressed air on the line, result in contamination of the machine and/or the foodstuff. Although the use of filters reduces the problem, it results in considerable complexity in monitoring and/or cleaning.

For this reason, the object of the present invention is to provide a gripper which does not have the disadvantages of the prior art.

The object is achieved by a gripper for use in a cutting machine, in particular a high-performance cutting machine, which is in reversible engagement with a bar-shaped foodstuff by the application of a negative pressure, wherein the gripper has a deformable membrane whereof the deformation generates a negative pressure between the membrane and the bar-shaped foodstuff.

The present invention relates to a gripper for use in cutting machines, in particular a high-performance cutting machine, in which the bar-shaped foodstuff is cut up into slices of foodstuff. This gripper is in reversible engagement with a bar-shaped foodstuff, for example with the one end thereof, by the application of a negative pressure, and fixes and/or guides this bar-shaped foodstuff, in particular while the last slices of foodstuff in the bar-shaped foodstuff are being cut. Furthermore, the gripper holds the remaining piece and guides it for example over a disposal chute, where it is expelled from the gripper and falls into the disposal chute.

According to the invention, this gripper has a deformable membrane whereof the deformation generates a negative pressure between the membrane and the bar-shaped foodstuff. As soon as the gripper abuts against the end of the bar-shaped foodstuff and preferably parts thereof, such as a cutting ring, have penetrated into the bar-shaped foodstuff by a certain amount, the membrane is deformed, as a result of which a negative pressure is produced between the gripper and the end of the bar-shaped foodstuff. This negative pressure endures that the bar-shaped foodstuff is kept at least in contact with the gripper, but preferably also ensures that the contact, in particular the shaping fit and/or force fit between the gripper and the end of the bar-shaped foodstuff, is improved. It is also possible to keep the deformation of the membrane constant, to decrease it or to increase it during engagement with the bar-shaped foodstuff, in order to adjust the negative pressure between the gripper and the bar-shaped foodstuff. Preferably, leak flows between the bar-shaped foodstuff and the gripper in the period during which the gripper is in engagement with the bar-shaped foodstuff are compensated.

The membrane may be any membrane familiar to those skilled in the art. It may be provided as a planar component or as a two-dimensional or three-dimensional component, for example being corrugated in form. Preferably, the membrane is shaped to include resilient material accumulators which stretch when the membrane is deformed. The membrane may be made from any material familiar to those skilled in the art. Preferably, however, it is made from an elastic material, in particular a synthetic material, particularly preferably a rubber-like material. The membrane may comprise a plurality of layers. The membrane is fixedly connected in its edge region to the housing of the gripper, with the result that this edge region does not move, or moves only negligibly, during deformation of the membrane.

The use of a membrane in grippers has the advantage that no particles of product can accumulate in the region around and behind the membrane. This makes the gripper according to the invention very simple to clean. No particles of foodstuff can penetrate between the membrane and the housing and/or into the lines attached to the housing.

The gripper according to the invention is very simple in construction and so it may be made at lower cost than grippers according to the prior art.

Preferably, the gripper has a cutter which cuts into the bar-shaped foodstuff, preferably into the end thereof. This cutter improves the force fit and/or form fit between the gripper and the cutter. Preferably, the cutter is a peripherally enclosed cutter, that is to say for example an annular cutter. As a result of this preferred embodiment of the present invention, leak flows between the gripper and the bar-shaped foodstuff are at least reduced. As an alternative to the cutter, in particular the cutting ring, or in addition, against the gripper another sealing means, for example an elastic sealing lip that abuts only against the bar-shaped foodstuff, in particular the end thereof, is arrangeable, in order to at least reduce leak flows when the negative pressure is applied.

The membrane may be deformed by any means familiar to those skilled in the art. For example, a negative pressure that deforms the membrane may be applied on the side of the membrane remote from the bar-shaped foodstuff. This negative pressure may be provided by a hydraulic or a pneumatic means. In the context of the invention, the term negative pressure means a pressure which is lower than the respectively prevailing ambient pressure. In another preferred embodiment, the membrane is made at least in part from a material which is attracted by a magnetic field, for example from a material containing iron. In that case, the deformation is preferably provided by an electromagnet which may at least be switched on or off but is preferably regulable. Those skilled in the art will appreciate that the membrane itself may be made at least in part from a magnetizable or electrically conductive material. In a further preferred embodiment, the membrane is deformed by another mechanical means which acts directly or indirectly on the membrane.

Preferably, the membrane is arranged in the gripper such that a positive pressure may also be generated therewith between the membrane and the bar-shaped foodstuff. As a result of this, the bar-shaped foodstuff, in particular an end piece that is not to be cut up, may be released from the gripper. In this case, the membrane is deformed in the direction of the bar-shaped foodstuff, in relation to the non-deformed position.

In a preferred embodiment, there is provided on the membrane an ejector which, when it is returned from the deformed position by which the negative pressure is generated between the gripper and the bar-shaped foodstuff into the non-deformed position, releases the bar-shaped foodstuff from the gripper. Preferably, the ejector projects out of the membrane in the direction of the bar-shaped foodstuff and hence comes into contact with the bar-shaped foodstuff before and/or while the latter abuts against the gripper.

This ejector may also be part of a sensor in order to establish whether a bar-shaped foodstuff is present and/or whether the bar-shaped foodstuff is abutting against the gripper. For example, as the gripper comes into engagement with the bar-shaped foodstuff, the bar-shaped foodstuff presses the sensor into the gripper, at least in certain regions. During this, the membrane is tensioned or its position changes and/or the pressure behind the membrane is increased. These changes are measurable. It is also possible to detect the change in position of magnetic membranes by means of inductive or capacitive sensors. On the basis of a corresponding signal, the controller of the cutting machine on which the gripper is mounted knows whether a bar-shaped foodstuff is abutting against the gripper.

Preferably, the membrane is deformed elastically. Particularly preferably, the membrane has spring elements which are stretched when the membrane is deformed. These spring elements may be generated for example by plastically shaped corrugations in the membrane.

In a further preferred embodiment of the present invention, the gripper hasa protection which is provided between the bar-shaped foodstuff and the membrane and which prevents the membrane from extending outside the gripper and for example being damaged by the cutting blade. Preferably, the protection is a perforated element, in particular a grating or a perforated plate. Particularly preferably, at least one form-fitting means is provided on this protection, for example in the form of a spike that penetrates into the end of the foodstuff and thus improves the form fit and/or force fit between the gripper and the end of the bar-shaped foodstuff.

In a preferred embodiment of the present invention, the gripper has a plurality of cutters which may for example be provided concentrically in relation to one another. Further preferably, or particularly preferably, the gripper has a plurality of negative pressure spaces which are separated from one another in particular by the cutters and/or sealing lips. A plurality of negative pressure spaces has the advantage of redundancy. Further, different negative pressures may be generated in these negative pressure spaces. Preferably, in each case two negative pressure spaces are separated by a space in which ambient pressure or positive pressure prevails. Positive pressure may in particular be used to release the end of the bar-shaped foodstuff from the gripper.

In a preferred embodiment of the present invention, the gripper has a grab, preferably two grabs, having claws, which improve the connect between the gripper and the grab.

The present invention further relates to a gripper assembly which has a plurality of the grippers according to the invention.

The statements made in respect of the gripper apply equally to the gripper assembly and vice versa.

Preferably, the grippers are provided next to one another and/or axially offset from one another.

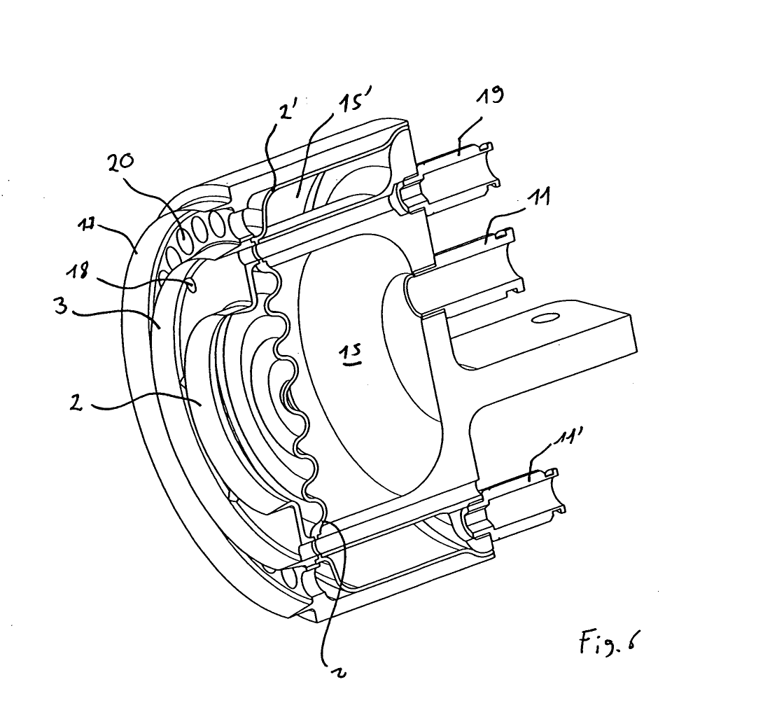

The invention will be explained below with reference to FIGS. 1 to 12. These explanations are merely examples and do not restrict the general concept of the invention. The statements apply equally to both subjects of the present invention.

FIGS. 1-3 show a first embodiment of the gripper according to the invention.

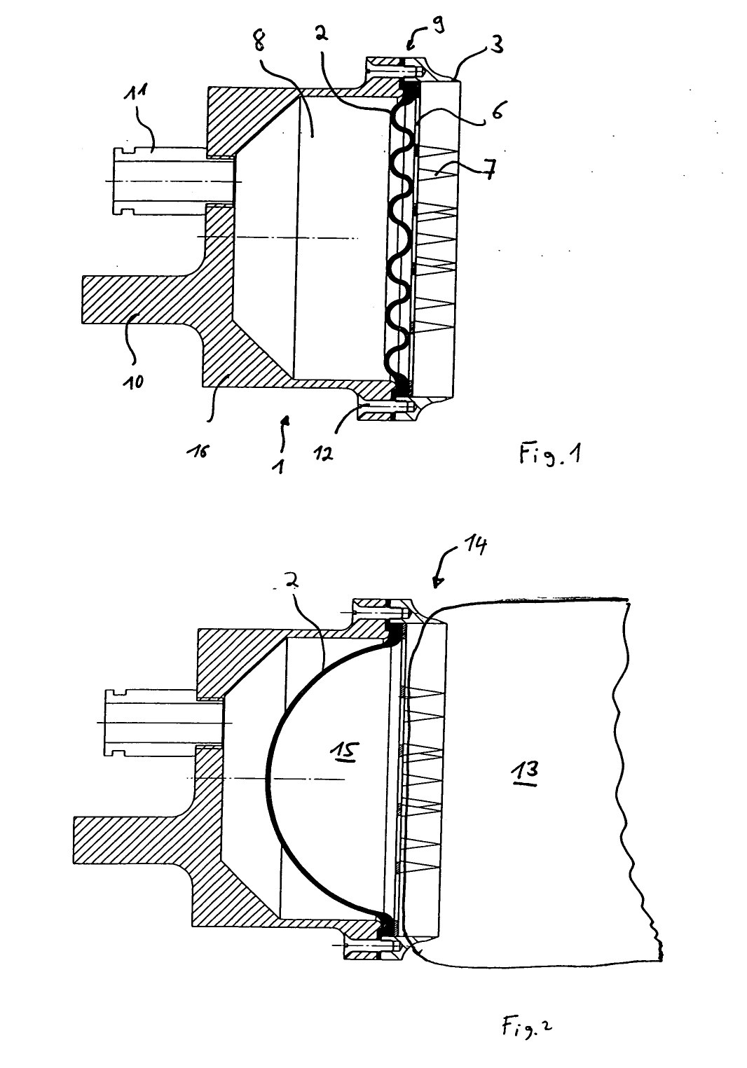

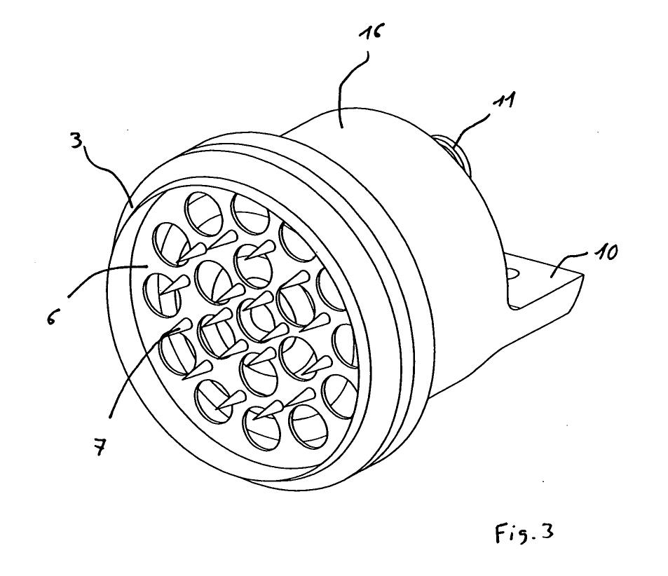

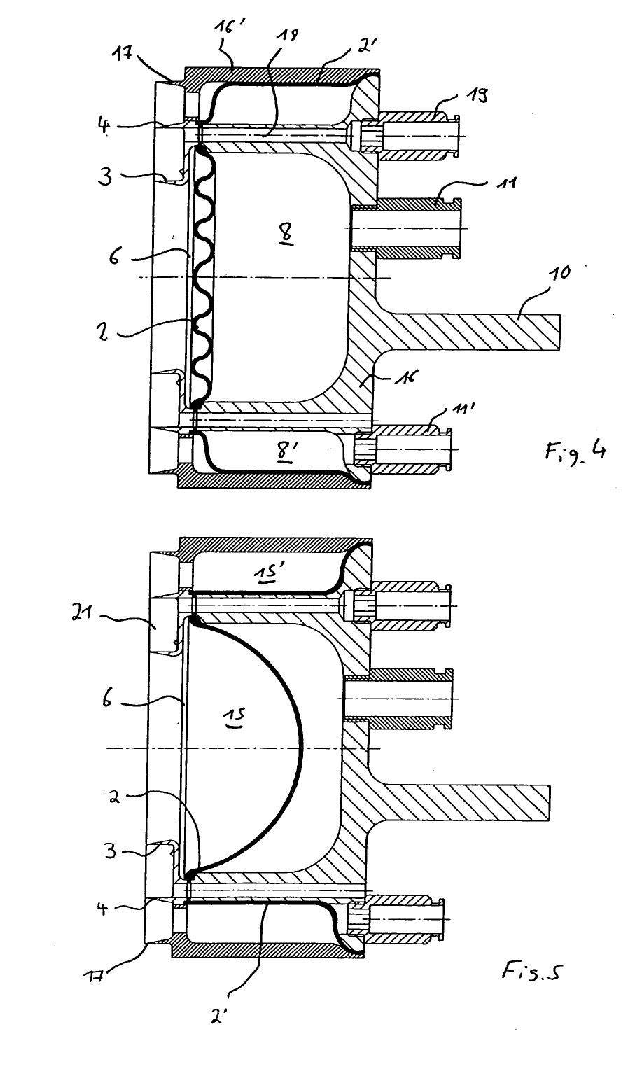

FIGS. 4-6 show a second embodiment of the gripper according to the invention.

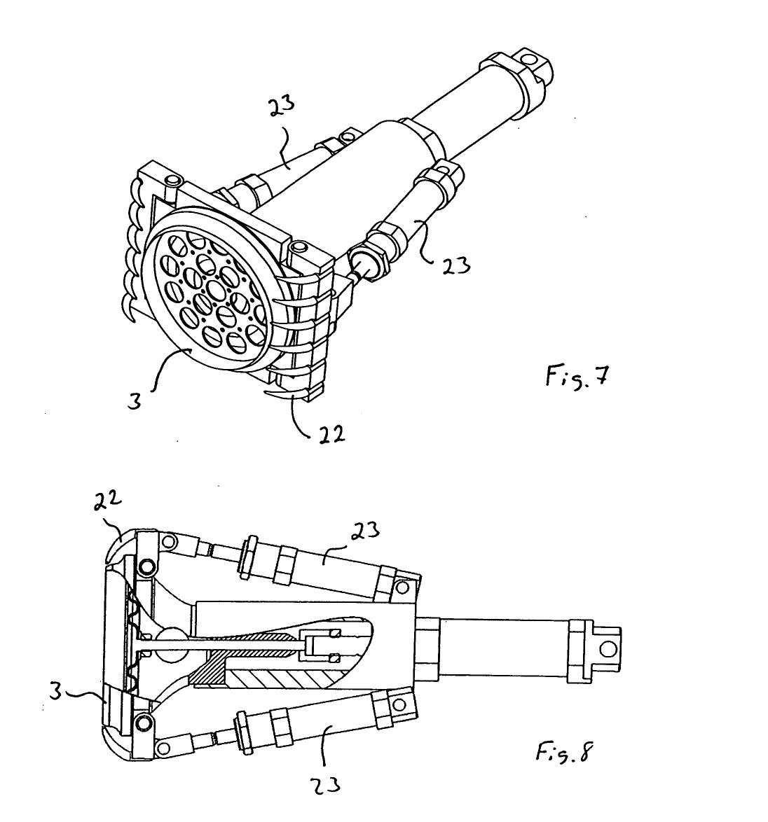

FIGS. 7-8 show a gripper with grabs.

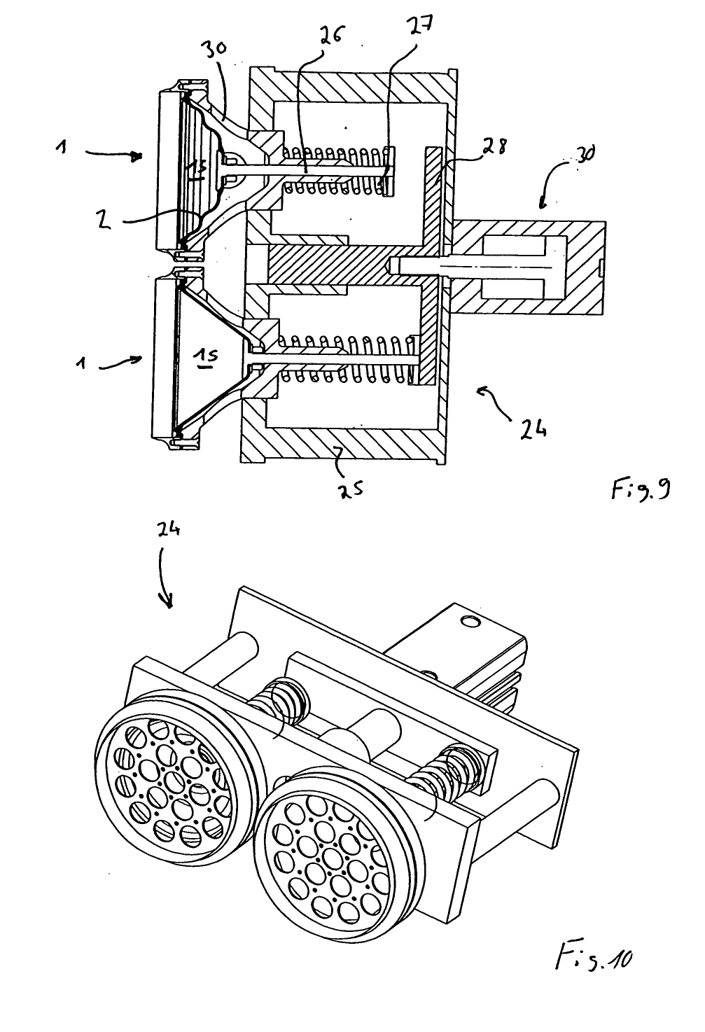

FIGS. 9 and 10 show the gripper assembly according to the invention.

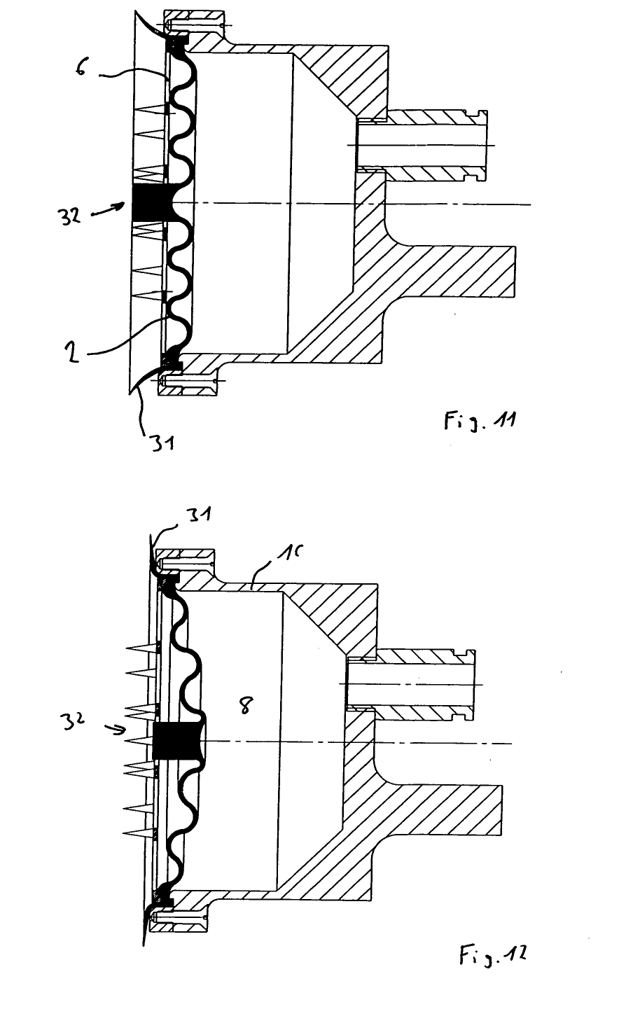

FIGS. 11 and 12 show a gripper having a membrane with ejector.

FIGS. 1-3 show a first embodiment of the gripper 1 according to the invention. This gripper has a housing 16 on which there is provided a securing means 10 by means of which the gripper can be secured to the cutting device. Furthermore, the housing 16 has a negative pressure attachment 11 to which a negative pressure hose connected to a negative pressure pump can be secured. This negative pressure attachment is connected to an expansion space for the membrane 8, with the result that a negative pressure can be generated in it. Furthermore, the gripper according to the invention has a membrane which in the present case is made from synthetic material and is provided in a corrugated form. The corrugations act as resilient material accumulators which lengthen reversibly on deformation and hence smooth the membrane. The edge of the membrane is connected to the housing 16, thereby the edge region is clamped between a flange on the housing 16 and a cutter 3 provided there. The cutter 3 may be reversibly fixed to the housing by means of screws 12, as a result of which the membrane is also secured to the housing. Those skilled in the art will appreciate that the membrane may also be secured to the housing 16, preferably reversibly, in any other desired way familiar to those skilled in the art, with the result that it may be exchanged, for example for purposes of repair. Also provided on the cutter 3 is a protection 6, here in the form of a perforated plate, which prevents the membrane from extending outside the gripper 1 and being damaged for example by a cutting blade. Provided on the protection 6, in this case the perforated plate, are form-fitting and/or force-fitting means, here in the form of spikes which improve the form fit and/or force fit between the gripper and the end of the bar-shaped foodstuff. FIG. 2 illustrates the situation after the gripper has been brought into contact with the end 14 of a bar-shaped foodstuff 13. The cutter 3, which in the present case is provided in annular form, and the spikes 7 have been at least partly pushed into the end 14 of the bar-shaped foodstuff 13. In particular the cutter 3 acts as a sealing means here to prevent false air from being drawn between the gripper and the bar-shaped foodstuff 13. Once the cutter 3 has been introduced into the end 14, negative pressure is generated in the expansion chamber 8 by way of the negative pressure attachment 11. As a result of this, the membrane 2 is drawn into the expansion space 8 and a negative pressure space 15 is produced between the membrane 2 and the end 14 of the bar-shaped foodstuff 13, as a result of which the contact and hence the form fit and/or force fit between the gripper and the end of the bar-shaped foodstuff is maintained or improved. In the present case, the membrane has material accumulators which in the present case are provided in the form of plastically shaped corrugations. When the membrane 2 is deformed these corrugations are first smoothed, and this is illustrated in FIG. 2. If a more extreme negative pressure is necessary in the negative pressure space 15, the membrane can be drawn further into the expansion space, wherein this deformation should not exceed the elastic region of the membrane. As soon as the bar-shaped foodstuff has been cut up, ambient pressure or positive pressure can be generated in the expansion space 8 by way of the attachment 11, as a result of which the membrane springs abruptly back into the shape illustrated in FIG. 2 and hence presses the end 14 of the bar-shaped foodstuff 13 away from the gripper, as a result of which the engagement between the gripper and the end of the bar-shaped foodstuff is released.

FIGS. 4-6 show a further embodiment of the gripper according to the invention. The inner region of this gripper corresponds substantially to that of the embodiment according to FIGS. 1-3, wherein two further cutters 4, 17 extend concentrically around the cutter 3. Furthermore, in the present case the gripper has a further membrane 2′ which extends around the periphery of the membrane 2. The membranes 2, 2′ may be provided in one piece or as two pieces. The membrane 2′ may be acted upon by negative pressure separately from the membrane 2, by way of a negative pressure attachment 11′. As a result, two mutually separated independent negative pressure spaces 15, 15′ are produced. Provided between the two membranes 2, 2′ are bores 18 which are provided with a venting and/or negative pressure attachment, with the result that a space at ambient or positive pressure is provided between the cutters 3, 4. The positive pressure may in particular be used to separate the end piece of the bar-shaped foodstuff from the gripper. The cutter 17 is provided on a separate housing part 16′ which, like the protection 6, may be disassembled from the housing 16. As a result of this, the membranes 2, 2′ are freely accessible and may thus be cleaned very simply and very intensively. FIG. 4 shows the gripper before it comes into engagement with the end of a bar-shaped foodstuff. FIG. 5 shows the situation once the bar-shaped foodstuff (not illustrated) has been brought into engagement with the gripper 1 and negative pressure has been applied to the gripper by way of the negative pressure attachments 11, 11′. The membranes have deformed such that a negative pressure, which fixes the end of the bar-shaped foodstuff to the gripper, is produced in the negative pressure spaces 15, 15′. Those skilled in the art will appreciate that the negative pressures applied in the expansion spaces 8, 8′ can be adjusted entirely separately from one another. This produces a certain redundancy. Furthermore, those skilled in the art will realize that a leak in one of the two negative pressure spaces 15, 15′ has no effect on the negative pressure in the other negative pressure space 15, 15′. No negative pressure is applied between the two cutters 3, 4. As soon as cutting up is complete, ambient, preferably positive, pressure is applied to this region 21 in order to release the end of the bar-shaped foodstuff from the gripper.

In the context of the invention, positive pressure is higher than ambient pressure.

FIGS. 7 and 8 illustrate a further embodiment of the gripper according to the invention. In the present case, grabs 22 are provided in the edge region of the cutter 3, and these can be rotated into and out of the bar-shaped foodstuff by means of the drive 23. This embodiment of the present invention generates particularly good form fit and/or force fit between the end of the bar-shaped foodstuff and the gripper, despite the fact that the latter has only one pair of grabs 22.

FIGS. 9 and 10 illustrate a gripper assembly 24 according to the invention having, in this case, two grippers 1 which substantially correspond to the embodiment according to the preceding figures. In the present case, the membrane is deformed not by negative pressure but by a linkage 26, which is spring-loaded and connected to the membrane 2. While the lower linkage and hence the deformation of the membrane 2 are in their end stage, there is still a certain displacement travel available in the case of the upper gripper, with the result that leak flows that are present can still be compensated. Before the bar-shaped foodstuff is brought into contact with the grippers of the gripper assembly 24, the pressing assembly 28 is displaced to the left by a piston and cylinder unit 30, with the result that the membranes each adopt their undeformed position. As soon as the bar-shaped foodstuff has come into contact with the grippers, the piston and cylinder unit moves the pressing plate 28 to the right and, overcoming the force of the springs, the linkage 26 is displaced to the right, as a result of which the membranes are deformed and a self-regulating negative pressure is produced in the negative pressure spaces 15. Those skilled in the art will appreciate that the gripper assemblies 21 may be provided axially offset from one another in order to be suitable for bar-shaped foodstuffs that do not have a planar end.

FIGS. 11 and 12 illustrate a preferred embodiment of the gripper according to the invention. Reference may substantially be made to the statements with respect to the preceding figures, in particular FIGS. 1 and 2. Unlike the gripper according to FIGS. 1 and 2, the gripper in the present case has a sealing lip 31 which is peripheral, in particular annnlar, in form and abuts against the bar-shaped foodstuff (not illustrated) and is deformed by the latter, as can be seen in particular from FIG. 12. As a result of this, leak flows, for example when a negative pressure is applied, are at least minimized. Those skilled in the art will realize that this sealing lip may be provided as an alternative or in addition to the cutter according to FIGS. 1 and 2.

Furthermore, the gripper according to FIGS. 11 and 12 has an ejector 32 which in this case is arranged on the membrane and may be provided in one or two pieces with the membrane 2. In the undeformed condition of the membrane 2 (cf. FIG. 11), this ejector 32 projects out of the protection 6 and, as illustrated in FIG. 12, is pressed to the right, at least partly into the housing 16 of the gripper, by the bar-shaped foodstuff as the latter comes into engagement with the gripper. As soon as the bar-shaped foodstuff has been cut up, either ambient or positive pressure is generated in the expansion space 8. As a result of this, the ejector 32 shoots out of the protection 6 again and in so doing releases the bar-shaped foodstuff from the gripper.

The ejector 32 may operate exclusively or additionally as part of a sensor. Because the bar-shaped foodstuff presses the ejector into the housing, the pressure in the expansion space 8 rises and the membrane 2 stretches or the position thereof changes. At least one of these changes may be detected by a sensor and passed on to a machine controller. The latter then knows that the gripper is in engagement with a bar-shaped foodstuff and may for example activate a means that brings about deformation of the membrane and hence generates a negative pressure between the membrane and the bar-shaped foodstuff. According to another example, the sensor may be used to establish whether for example an end piece of the bar-shaped foodstuff has been expelled from the gripper, that is to say whether the latter is available for engagement with a new bar-shaped foodstuff.

Those skilled in the art will appreciate that the sealing lip may be provided independently of the ejector and vice versa.

### LIST OF REFERENCE NUMERALS

1 Gripper
2, 2′ Membrane
3 Cutter
4 Cutter
5 Means, mechanical means
6 Protection, grating, perforated plate
7 Form-fitting and/or force-fitting means, spike
8, 8′ Expansion space for the membrane
9 Securing region for the membrane
10 Securing means for the gripper
11, 11′ Negative pressure attachment
12 Securing means, screw
13 Bar-shaped foodstuff
14 Rear end of the bar-shaped foodstuff
15, 15′ Negative pressure space
16, 16′ Housing
17 Cutter
18 Bore, channel
19 Venting, positive pressure attachment
20 Recess, bore
21 Ambient or positive pressure space
22 Grab
23 Drive of the claw
24 Gripper assembly
25 Housing
26 Linkage
27 Spring means
28 Pressing assembly
29 Piston and cylinder unit
30 Ventilation opening
31 Sealing lip
32 Ejector

1. A gripper for a high-performance cutting machine,
wherein the gripper is in reversible engagement with a bar-shaped foodstuff by the application of a negative pressure,
wherein the gripper has a deformable membrane whereof the deformation generates a negative pressure between the membrane and the bar-shaped foodstuff.

2. The gripper as claimed in claim 1, wherein the gripper has a cutter which cuts into the bar-shaped foodstuff.

3. The gripper as claimed in claim 1, wherein the membrane is deformed by hydraulic, pneumatic, magnetic or other mechanical means.

4. The gripper as claimed in claim 1, wherein a protection is provided for the membrane and the bar-shaped foodstuff.

5. The gripper as claimed in claim 1, wherein the gripper has at least one form-fitting means, which is arranged on the protection.

6. The gripper as claimed in claim 1, wherein the gripper has a plurality of cutters and/or a plurality of negative pressure spaces.

7. The gripper as claimed in claim 6, wherein the negative pressure spaces are separated by an ambient pressure or positive pressure space.

8. The gripper as claimed in claim 1, wherein the gripper has a grab.

9. The gripper as claimed in claim 1, wherein the gripper has an elastic sealing lip.

10. The gripper as claimed in claim 1, wherein the gripper has an ejector which releases the bar-shaped foodstuff from the gripper and is provided on the membrane.

11. The gripper as claimed in claim 10, wherein the ejector is part of a sensor.

12. The gripper as claimed in claim 1, wherein the gripper has a deformable membrane whereof the deformation generates a positive pressure between the membrane and the bar-shaped foodstuff.

13. A gripper assembly, having a plurality of grippers as claimed in claim 1.

14. The gripper assembly as claimed in claim 13, wherein the grippers are provided next to one another and/or axially offset from one another.

15. A high-performance cutting machine for foodstuffs comprising:
a gripper which can be brought reversibly into engagement with a bar-shaped foodstuff by the application of a negative pressure,
wherein the gripper has a deformable membrane whereof the deformation generates a negative pressure between the membrane and the bar-shaped foodstuff.

16. The high-performance cutting machine as claimed in claim 15, wherein the gripper has a cutter which cuts into the bar-shaped foodstuff, and
wherein the membrane is deformed by hydraulic, pneumatic, magnetic or other mechanical means.

17. The high-performance cutting machine of claim 15, wherein a protection is provided for the membrane and the bar-shaped foodstuff,
wherein the gripper has at least one form-fitting means that is a spike, which is arranged on the protection; and
wherein the gripper has a plurality of cutters and/or a plurality of negative pressure spaces and the negative pressure spaces are separated by an ambient pressure or positive pressure space.

18. The high-performance cutting machine of claim 15, wherein the gripper has a grab;
wherein the gripper has an elastic sealing lip; and
wherein the gripper has an ejector which releases the bar-shaped foodstuff from the gripper and is preferably provided on the membrane and the ejector is part of a sensor.

19. The high-performance cutting machine of claim 18, wherein the gripper has a deformable membrane whereof the deformation generates a positive pressure between the membrane and the bar-shaped foodstuff.

20. The high-performance cutting machine of claim 17, wherein the gripper has a plurality of grippers; and
wherein the grippers are provided next to one another and/or axially offset from one another.
